(19) United States
(12) Patent Application Publication
(10) Pub. No.: US 2006/0248478 A1
(43) Pub. Date: Nov. 2, 2006

(54) Sensing input actions

(76) Inventor: Forrest Liau, Boston, MA (US)

Correspondence Address: FISH & RICHARDSON PC, P.O. BOX 1022, MINNEAPOLIS, MN, 55440-1022, US

(21) Appl. No.: 11/333,100

(22) Filed: Jan. 17, 2006

Related U.S. Application Data
(60) Provisional application No. 60/644,739, filed on Jan. 18, 2005.

(51) Int. Cl. G09G 5/08

(52) U.S. Cl. 715/863; 715/701; 715/702; 345/158

(57) ABSTRACT

Receiving input from a person includes sensing a manual interaction performed by the person, determining a posture of a portion of the person's body, and generating a signal based on the sensed interaction and the determined posture.

### CROSS-REFERENCE TO RELATED APPLICATIONS

This application claims the benefit of U.S. Provisional Application No. 60/644,739 filed Jan. 18, 2005, incorporated herein by reference.

### STATEMENT OF GOVERNMENT RIGHTS

This invention was made with Government support under contract number W911QY-D5-C-0021 awarded by the Department of Defense, Army. The Government has certain rights in the invention.

### BACKGROUND

The invention relates to sensing input actions.

The ability to efficiently and effectively interact with and control electronic devices is critical in many professions, especially when a dangerous mission-critical operation involves the proper coordination and manipulation of electronic devices by an individual. Individuals like astronauts, pilots, vehicle drivers, police officers, rescue divers, soldiers, etc. often interact with (often complex) machinery and electronic devices to accomplish their tasks, and sometimes, even to survive.

A person often interacts with a device using one or both hands to manually issue control commands. For example, a robot operator may need to manually steer a robot using a joystick; a police officer may need to manually switch stations and activate a push-to-talk button in order to communicate; a soldier may need to let go of his/her rifle in order to change modes on his/her heads-up display. In some cases, a person frees up a hand, by letting go of anything they might have been previously holding, in order to interact with their electronic devices.

In one example of controlling an electronic device without necessarily needing to have a free hand, a person can control an electronic device using verbal commands. Verbal messages achieve near-instant information transfer, but they may be difficult to work with when (1) reliable voice recognition and processing algorithms are inaccessible, (2) ambient noise levels are high (e.g., during gunfire), (3) silence is critical (e.g., during a police operation), (4) speech production is impeded (e.g., during a scuba diving mission), (5) speech is labored (e.g., when the person is out of breath and gasping for air), (6) the person is listening attentively (e.g., to instructions) and unable to speak at the same time without missing important information, (7) the person is already in the middle of speaking and cannot interdisperse verbal commands into the existing stream of dialogue (e.g., an individual may need to continuously report information verbally while operating a device or surveying an electronic map).

### SUMMARY

In one aspect, the invention features a method for receiving input from a person. The method includes sensing a manual interaction performed by the person; determining a posture of a portion of the person's body; and generating a signal based on the sensed interaction and the determined posture This aspect can include one or more of the following features.

The manual interaction includes a force applied by the person against an object.

The force includes a force applied in an isometric action.

The force includes a force applied in a direction non-orthogonal to a surface of a portion of the object.

The manual interaction is performed by the portion of the person's body.

The portion of the person's body includes a hand.

The posture includes a shape state of at least one portion of the hand.

The manual interaction includes a force applied by at least one finger of the hand.

The posture includes a state of the portion of the person's body with respect to an object.

The posture includes a position of the person's hand within a pocket.

In another aspect, the invention features an article of manufacture. The article includes a wearable interface; and one or more sensors arranged in the wearable interface to sense a manual interaction performed by a person wearing the wearable interface, and determine a posture of a portion of the body of the person wearing the wearable interface.

This aspect can include one or more of the following features.

The manual interaction includes a force applied by the person against an object.

The force includes a force applied in an isometric action.

The force includes a force applied in a direction non-orthogonal to a surface of a portion of the object.

The portion of the person's body includes a hand.

The wearable interface includes handwear.

The handwear includes a glove.

At least one of the sensors includes a bend sensor.

The wearable interface includes a pocket.

At least one of the sensors includes shape-sensitive material.

The wearable interface includes a first wearable article including a sensor arranged in the first wearable article to sense a manual interaction performed by the person, and a second wearable article including a sensor arranged in the second wearable article to determine a posture of the portion of the body.

The sensors are arranged in the wearable article to sense the posture of the portion of the body performing the manual interaction.

In another aspect, the invention features a method for receiving input from a person. The method includes sensing a manual interaction with a wearable interface located between a portion of a person's body and an object while the portion of the body is in a posture associated with the object; and generating a signal based on the sensed interaction.

This aspect can include one or more of the following features.

The portion of the body being in a posture associated with the object includes the portion of the body in contact with the object.

Sensing the manual interaction with the wearable interface includes sensing a force applied by the person on the wearable interface against the object.

The force includes a force applied in an isometric action.

The force includes a force applied in a direction non-orthogonal to a surface of a portion of the object.

Sensing the manual interaction with the wearable interface includes sensing rolling of the portion of the person's body on the wearable interface against the object.

The method further includes determining which of multiple pre-determined postures associated with the object is being assumed by the portion of the body.

Generating the signal based on the sensed interaction includes generating a signal in response to the sensed interaction based on the determined posture.

Generating the signal based on the sensed interaction includes generating a signal in response to the sensed interaction based on information indicating a type of the object.

In another aspect, the invention features a system for receiving input from a person. The system includes a wearable interface including one or more sensors arranged to sense a manual interaction between a portion of the person's body and an object, and arranged to be compatible with a posture of the portion of the body associated with the object. The system includes an input module in communication with the wearable interface including circuitry to generate a signal based on the sensed interaction.

This aspect can include one or more of the following features:

The portion of the body being in a posture associated with the object includes the portion of the body in contact with the object.

Sensing the manual interaction between the portion of the person's body and the object includes sensing a force applied by the person against the object.

The force includes a force applied in an isometric action.

The force includes a force applied in a direction non-orthogonal to a surface of a portion of the object.

Sensing the manual between the portion of the person's body and the object includes sensing rolling of the portion of the person's body on a surface of a portion of the object.

The input module is in communication with the wearable interface over at least one of a wired channel, a wireless channel, or an optical channel.

In another aspect, the invention features a method for receiving input from a person. The method includes sensing a force applied to a wearable interface located between a portion of a person's body and an object; determining a direction associated with the sensed force.

This aspect can include one or more of the following features.

Sensing the force applied to the wearable interface includes sensing a force applied to a plurality regions of the interface.

Determining a direction associated with the sensed force includes determining a difference in force applied to the plurality of regions of the interface.

In another aspect, the invention features a system for receiving input from a person. The system includes a wearable interface including one or more sensors arranged to sense a force applied to the interface located between a portion of a person's body and an object; and an input module in communication with the interface including circuitry to determine a direction associated with the sensed force.

This aspect can include one or more of the following features.

The wearable interface is configured to determine a difference in force applied to regions of the interface, and transmit a signal indicative of the difference to the input module.

The circuitry is configured to determine the direction associated with the sensed force based on the signal.

The wearable interface is configured to transmit a plurality of signals indicative of force applied to a plurality regions of the interface.

The circuitry is configured to determine a difference in force applied to regions of the interface based on the plurality of signals.

Aspects of the invention can include one or more of the following advantages:

The system automatically translates postures, manual interactions, or a combination of both, into control information that can be used to direct and control the operation of an electronic device without requiring the person's hand(s) to be free or empty. This process makes it convenient for a person to control his/her electronic devices, for example, when the use of the hand(s) to operate the device could result in a dangerous situation. For example, the system is able to sense user input in situations in which the user's hand(s) are occupied, including: (1) when the user's hand is in a holding or grasping posture (e.g., on a steering wheel, the safety rails of a speeding boat, or a rifle grip), (2) when the user is protecting his/her hands from adverse conditions (e.g., in freezing weather; instead, they can operate their electronics from within a warm jacket pocket), or (3) when the user has his/her hand in a protective and/or defensive position (e.g., mortar crew cover their ears with their hands to block out the deafening sounds of firing mortars). In these cases, a user can still operate an electronic device without having to abandon whatever their hands are currently doing.

The system can be used while a person is holding any item the person may desire to hold by defining the library of control commands to be compatible with manual interactions and/or postures the held item may allow. A person may hold something, or a person may place a hand on something simply as a means for having something stable to press against (e.g., a wall, a body part, a tree trunk).

The system can include components that are part of a wearable ensemble. Thus, the system can conveniently accommodate the user as he/she goes about their routines. For example, instead of fixing a control device onto a soldier's rifle and running a power/data cable between the rifle and the soldier's computer to enable hands-on-weapon input, the system can be used to achieve the same capabilities while keeping the input hardware on the soldier rather than on the rifle, allowing the soldier to be more free from his/her weapon.

Other features and advantages of the invention will become apparent from the following description, and from the claims.

### DESCRIPTION OF DRAWINGS

FIG. 1 is a block diagram of an input sensing system.

FIG. 2 is a black diagram for a process of communicating control information.

FIG. 3 is a front view of an exemplary input glove, illustrating the placement of proportional force sensors.

FIGS. 4A and 4B are back and front views of an exemplary input glove for a vehicle driver.

FIGS. 5A and 5B are back and front views of an exemplary input glove for a robot operator.

FIGS. 6A and 6B are a front view, and a circuit representation, respectively, of an exemplary roll sensor.

FIGS. 7A and 7B are an exemplary shear force sensor and its exploded view, respectively.

FIGS. 8A and 8B are an outside and inside view, respectively, of an exemplary control pocket.

FIG. 9 is a front view of an exemplary input glove with processor and conductors.

FIG. 10 is a block diagram of an exemplary personal system including a soldier input glove.

FIGS. 11A, 11B and 11C are views of postures associated with manual interaction for inputting via an exemplary soldier glove.

FIGS. 12A and 12B are back and front views of an exemplary input glove for a commander.

FIG. 13 is a block diagram of an exemplary input glove system for a commander.

FIG. 14 is a view of an armband with bioelectric sensors for isometric input.

### DESCRIPTION

### 1 Overview

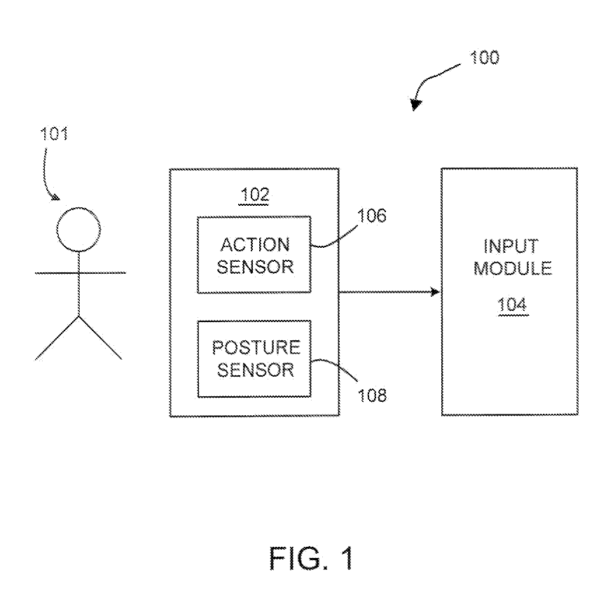

Referring to FIG. 1, an input sensing system 100 includes a wearable interface 102 that senses manual interaction (e.g., an isometric action) from a person 101 to generate a signal that is transmitted to an input module 104. The interface 102 is, in some implementations, a wearable interface. For example, sensors are incorporated into a wearable article such as a glove, a coat pocket, or other type of handwear or article of clothing. The input module 104 is in communication with the interface 102 over a communication channel (e.g., a wired channel, a wireless channel, or an optical channel such as a fiber optic channel). In some implementations, the input module 104 may be incorporated into the same article of clothing including the interface 102. In other implementations, the input module 104 may be incorporated into a local device (e.g., a mobile computing device) used by the person wearing an article of clothing that includes the interface 102, or incorporated into a remote device (e.g., tracking station) in communication with the interface 102.

The input module 104 can be, for example, incorporated into a computing device used by the person wearing a glove that includes the interface 102. In this case, the input module 104 interprets the received signal as a signal for controlling the computing device. Alternatively, the input module 104 can be an input module for a communication device carried by the person wearing a glove that includes the interface 102. In this case, the input module 104 interprets the received signal as a signal to be transmitted by the communication device. The transmitted signal can represent, for example, directional information as described in more detail in U.S. patent application Ser. No. 11/154,081, incorporated herein by reference.

In one implementation, a person issues commands to an electronic device using predetermined input actions sensed by one or more action sensors 106 arranged in the interface 102 and interpreted by the input module 104. For a given operating mode of the system 100, the input actions are selected to correspond to body positions (e.g., hand postures) associated with a task that a person may be performing. For example, the input actions can include isometric actions that a person is able to perform while assuming a hand grasping posture (e.g., a configuration of a hand on an object such as the hand grip of a rifle). There may be multiple hand grasping postures that are compatible with the isometric actions, as described in more detail below.

An isometric action involves the activation of muscles (e.g., muscular operation against resistance), but only a small amount of movement, or no movement. Thus, the isometric action can be performed while maintaining a given posture. In some implementations, the interface 102 includes pressure sensors imbedded in a glove and activated by a person holding or otherwise in contact with an object that has limited freedom of movement (and so offers resistance), and applying a recognizable pressure on the object. Though the interface 102 may be configured to sense isometric actions against a particular type of object, such as a rifle hand grip, the interface 102 is also able to operate with other objects. For example, if a person wearing a glove including the interface 102 is not currently holding a rifle hand grip, the person is able to perform the isometric actions while holding a portion of his body (e.g., his arm). In other implementations, the interface 102 includes bioelectric sensors (e.g., an electromyogram sensor), placed on a person's arm, to detect muscular activation.

In some implementations, the interface 102 senses an isometric action based on multiple possible postures assumed by a person. Different commands can be issued based on one or both of an isometric action and a posture determined by one or more posture sensors 108 arranged in the interface 102.

A posture sensor 108 can determine a configuration of a portion of a person's body. For example, if a hand is grasping a rifle hand grip and a bend-sensitive posture sensor 108 determines that a designated finger is extended, then the input module 104 generates a first signal in response to a sensed isometric action. If the bend-sensitive posture sensor 108 determines that the designated finger is bent, then the input module 104 generates a second signal in response to the sensed isometric action.

Alternatively, a posture sensor 108 can determine a position of a portion of a person's body with respect to an object. For example, a stretch-sensitive posture sensor 108 integrated into an article of clothing such as a jacket pocket can determine whether a hand is in an stretched posture that activate the sensor 108 beyond a threshold, or in an unstretched posture that does not activate the sensor 108 beyond a threshold.

### 2 Communicating Control Information using the Input Sensing System

In one implementation of the system 100, a person wears a glove with embedded sensors that include a range of sensors placed at selected positions along the hand. These sensors can be used to measure and detect a range of information about the hand and the arm, for example.

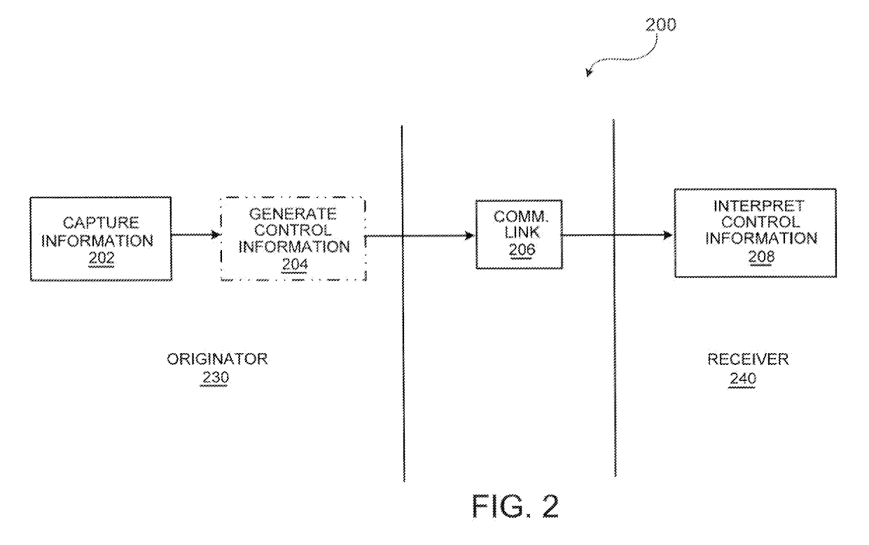

FIG. 2 illustrates a process 200 for communicating control information, and optionally other information, from an originator to one or more receiving entities using the system 100. For illustrative purposes, the method is described using one transmitting entity (the originator 230) and one receiving entity (the receiver 240), but the process is not limited to one of either entity, and also facilitates multiple originators and/or multiple receivers of various types.

Each step of the process is described in greater detail below. Certain steps may be omitted, and the order of these steps as presented may be changed for particular implementations. For example, the generation of control information step 204 can be omitted if the sensed information requires no further processing, or it can be performed after transmission over the communication link 206 by the receiver 240.

2.1 Capturing Information

The process 200 includes capturing information 202 from an originator 230. This information can include, for example, finger bend state, finger movement, wrist twist state, hand orientation, hand posture, hand grasping state, hand force distribution, directional information, touch information, object proximity, shear forces, multiaxial forces, muscle extensions/stretch, acceleration, etc. This information can also be captured in any manner appropriate for a particular application (e.g., by using one or more sensors to directly or indirectly determine bend, torque, acceleration, nerve conduction, muscle contraction, etc.)

2.2 Generating Control Information

The process 200 also includes generating control information 204 from the captured information 202. The intermediate information can take any form that can be interpreted and processed by the receiver. The intermediate information can also be, or can be a translation of, a function of, or some combination of the captured information 202 and other information, for example, time information, originator identity, receiver identity, etc.

In one implementation, the control information is a single code that is an index into a library of possible commands. In another implementation, the control information is a pair of numbers representing the amount of x- and y-movement, such as is necessary to direct a computer cursor to a new location.

In one implementation, the generation of control information 204 occurs after the communication link 206 on the receiver 240 side (e.g., when the originator is unable to process the captured information 202 for some reason). In other implementations, the control information is generated 204 on the originator 230 side (which may be more efficient than sending the captured information in its raw form in some cases).

2.3 Communication Link

The control information is communicated to a receiving entity via a communication link 206. The control information can be communicated in any suitable fashion, and over various types of links 206 depending on the application. For example, radio frequency or other radiation-based communication may be used for intermediate communication distances. As one example, for short-range applications, Bluetooth frequencies may be used. Underwater communication would favor sonic transmission means. Cable or fiber-based methods may also be implemented. Communication relay stations may be utilized. Information transmission can occur constantly, on demand, or in another fashion as needed.

In one example implementation, each transmission includes the following three items: (1) a sender ID; (2) a recipient code; and (3) control information, and possibly other items. Every send/receive unit has an ID that has been preprogrammed into the communications device. When a unit sends a transmission, its ID is sent first as the sender ID. Then a code is sent for the intended set of recipients (a single entity, a set of entities or a broadcast to all entities). The control code specifies some command that may optionally require that extra information be sent.

2.4 Interpret Control Information

The process 200 can also include interpreting control information 208. This can optionally include translation of the control information into a form suitable for processing by the receiver. In one implementation, to continue an example from above, this process 200 uses the received code as an index into a table of possible commands, and retrieves the corresponding set of instructions that are then followed by the receiver 240.

### 3 Examples

The following examples illustrate implementations of control systems incorporating an input sensing system. Various features of some examples can be omitted or combined with features from other examples.

3.1 Crane Operator Glove

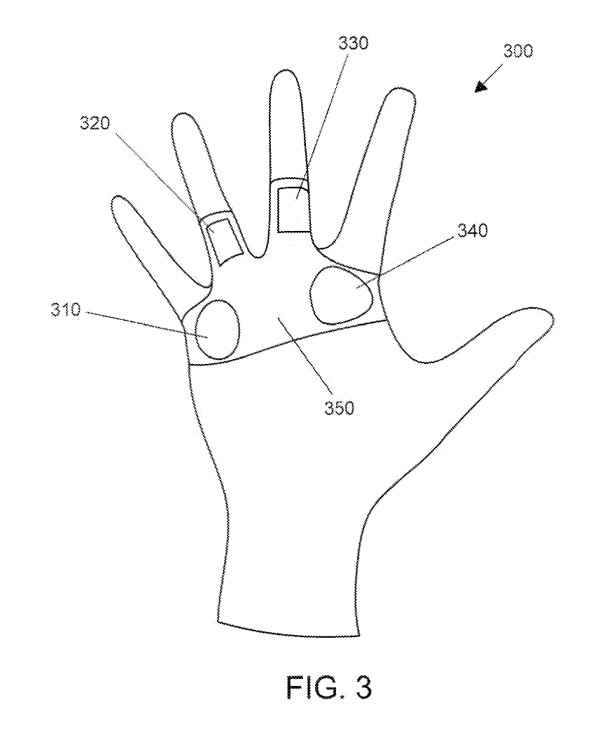

Referring to FIG. 3, a crane operator wearing a handwear 300 can control the operation of a construction crane (e.g., a hydraulic crane) capable of four directions of payload movement: lift, lower, turn right and turn left. Pressure sensors 310, 320, 330 and 340 are placed at locations on the fabric 350 that allow the pressure distribution of the operator's hand (e.g., due to isometric actions) to move the boom of the crane. For example, pressure sensor 310 is mostly affected when the operator torques his hand to the right while holding a rail, and it can then cause the rotex gear to rotate the boom to the right. Similarly, pressure sensor 320 senses when the operator's hand torques downward, and electronically signals the winch to lower the boom. Additionally, posture sensing fabric 350 can detect when the operator's hand is holding a particular object, causing the handwear 300 to be in crane control mode.

3.2 Patrol Driver Glove

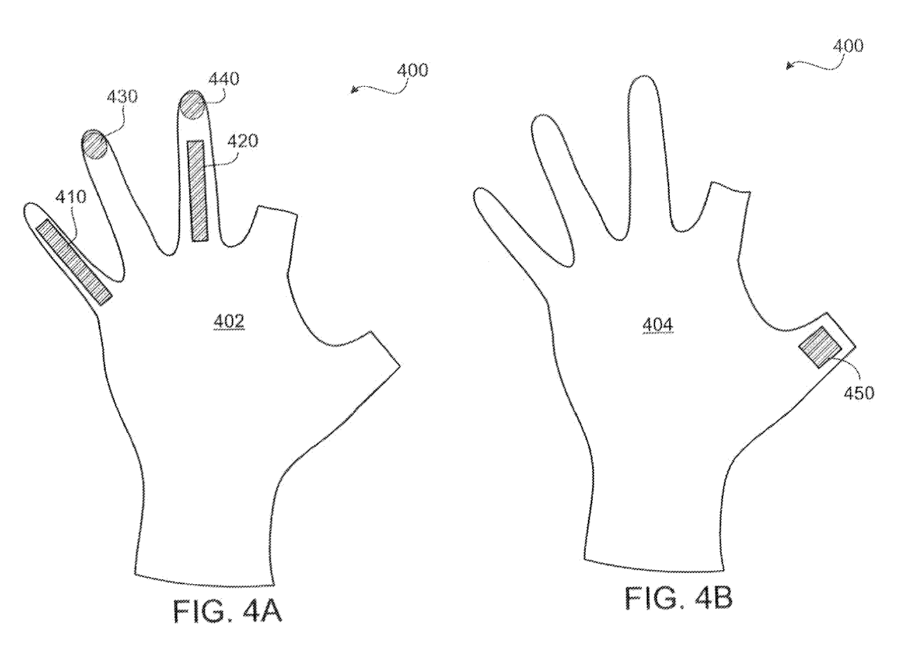

Referring to FIGS. 4A and 4B, a patrol car driver wearing input glove 400 can control multiple devices such as a GPS navigation unit and a two-way radio. FIG. 4A shows a backside 402 of the left-handed glove 400, and FIG. 4B shows a frontside 404 of the glove 400. Sensors 410 and 420 on the backside 402 of the glove 400 detect finger bend posture, and can also detect forces applied on the pressure sensors 430 and 440 at the fingernail areas of the glove 400 (e.g., by the thumb while the hand is on the steering wheel) and also force applied on the wheel by the thumb area 450 on the frontside 404 of the glove 400. The state of these sensors is captured 202 and used to generate control information 204 that can, for example, zoom in on a GPS map, change a radio channel or activate a push-to-talk feature. The control information is sent by the glove 400 over a physical connection link 206 to the appropriate target device, which can then be interpreted 208 by a receiving device to effect the desired action.

3.3 Robot Glove

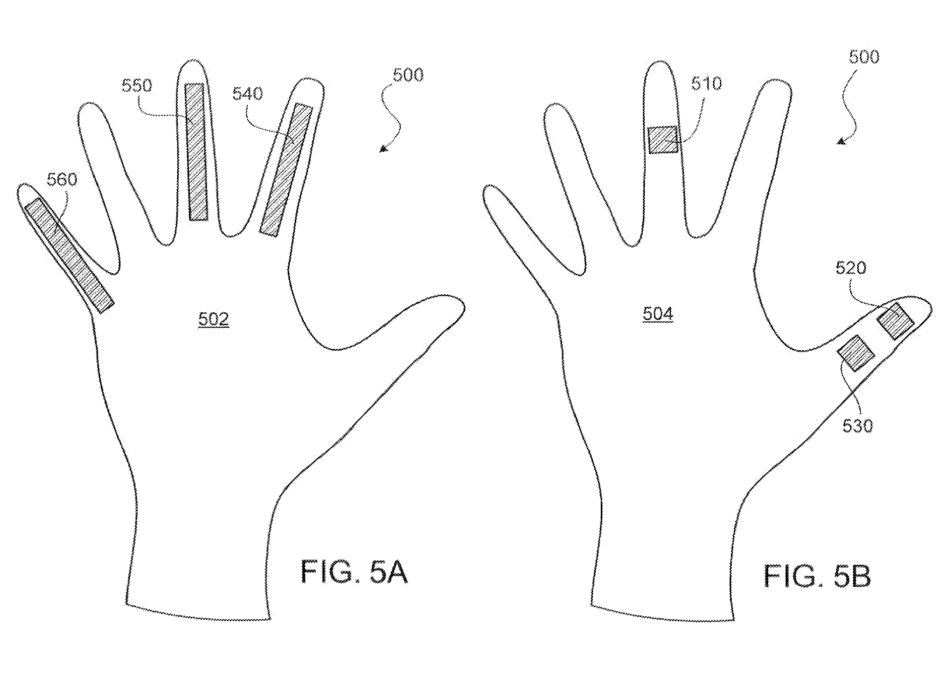

Referring to FIGS. 5A and 5B, a robot operator originator 230 is able to remotely operate a robotic device receiver 240. The operator wears a right-handed glove 500, and through a combination of the bend state of the fingers, the forces applied by the hand on the front surface of the hand, and the application of forces on a thumb pad, the operator can steer and manipulate a robot (while maintaining his grip on a rifle or a radio for example). FIG. 5A shows a backside 502 of the glove 500, and FIG. 5B shows a frontside 504 of the glove 500. Information about the state of the operator's hand is captured 202 via force sensors 510, 520, 530 on the frontside 504, and posture sensors 540, 550, 560 on the backside 502, and is used to generate control information 204. For example, a particular posture and force distribution may activate robot camera mode on the operator's eyepiece.

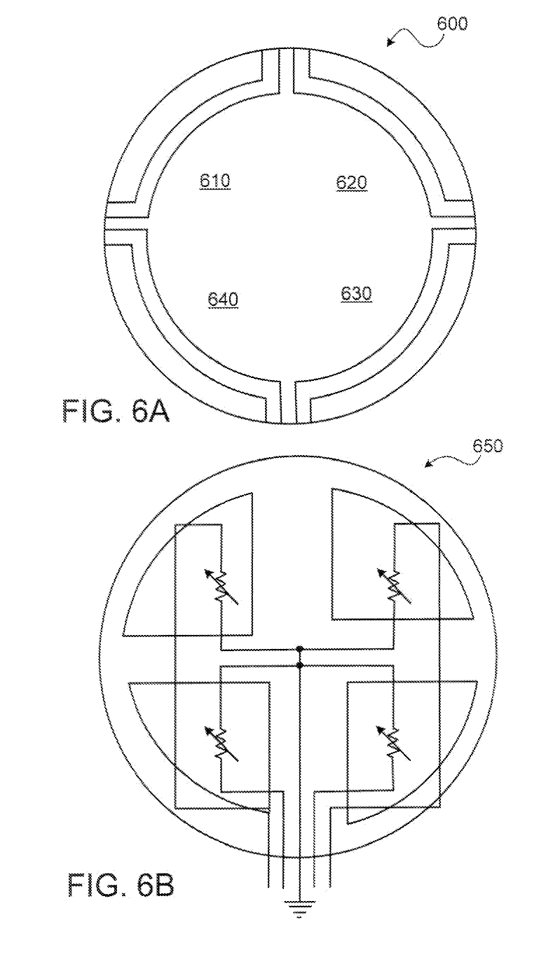

For directional control (e.g., of a robot-mounted camera) the force sensor 520 on the thumb portion of the glove 500, for example, can include a roll sensor 600 (FIG. 6A). The roll sensor 600 includes pressure-sensitive areas 610, 620, 630, and 640. The roll sensor 600 includes a circuit 650 (FIG. 6B) that generates a signal representing the amount of pressure detected by each of the pressure sensitive areas, respectively. Thus, the values of the four signals can be used to determine a direction associated with a force applied to the roll sensor 600.

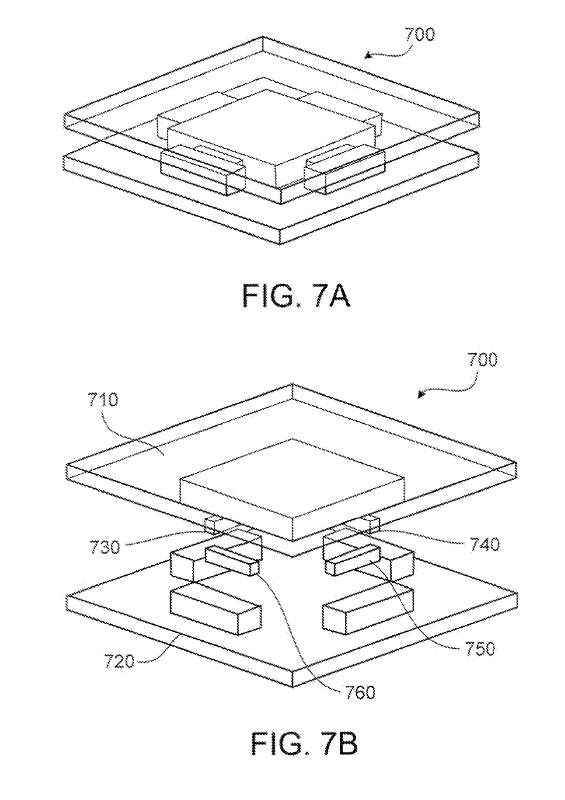

The force sensor 520 can include a shear sensor 700 (FIGS. 7A and 7B). FIG. 7A shows a view of the shear sensor during operation. FIG. 7B shows an exploded view of the shear sensor 700 including a top part 710, a bottom part 720, and pressure-sensitive components 730, 740, 750, and 760. When a person is wearing the glove 500 and holding an object, the shear sensor 700 detects a force applied in a direction non-orthogonal to a surface of a portion of the object. The shear sensor 700 can utilize, for example, a quantum tunneling composites (available from Peratech Ltd.).

The force sensor 520 can include a combination of roll sensors, shear sensors, or other types of force sensing components. The posture sensors can be configured and arranged in the glove 500 to detect bend state of fingers, or other shape state of a portion of the hand.

Control information can also include directives that correspond to “switch to robot control mode”, “stop moving”, “change robot configuration”, etc. This control information is then relayed from the glove 500 to the robotic device, which can then be interpreted 208 by the robotic device, optionally taking into account information such as current robot orientation, amount of fuel remaining, etc., to generate a series of commands (e.g., motor actuation) to execute the desired operations.

3.4 Device Control Clothing

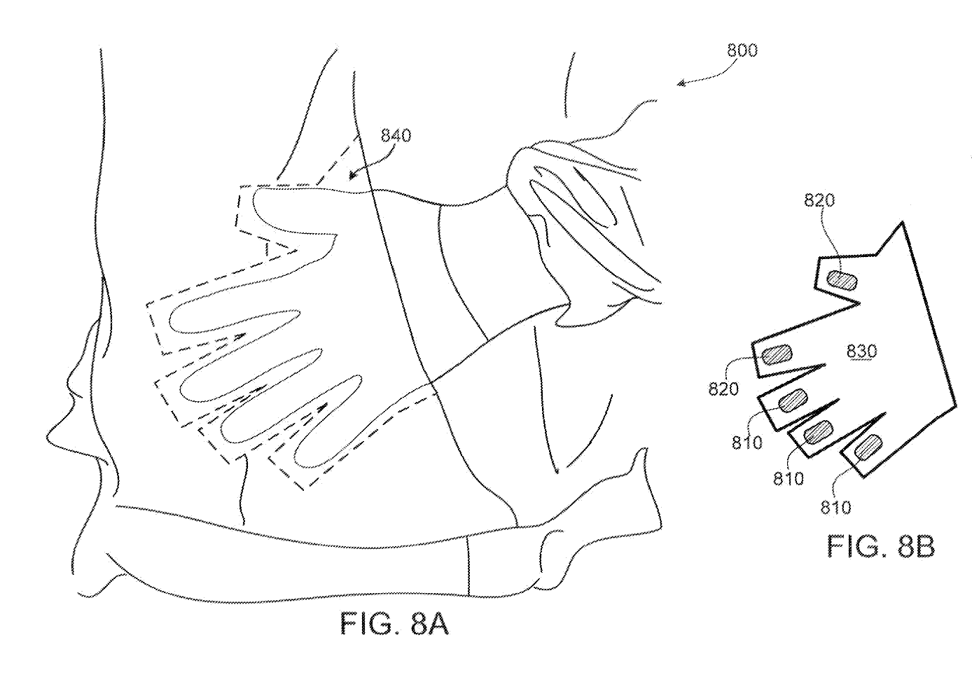

Referring to FIGS. 8A and 8B, a user wears one or more articles of textile clothing (e.g., a jacket and/or pants) in which pockets are networked so that a hand in a pocket can operate an electronic device located in another pocket of the same or another article of clothing. In this manner, the wearer of a jacket 800, for example, can operate a radio, multimedia player, cell phone, etc. located in his/her pants pocket (e.g., causing the volume or channel to change, pausing and playing, etc.), or an eyepiece display (e.g., causing the brightness or opacity to change, etc), without needing to remove his/her hands from the jacket pocket. Additionally, no external remote is necessary; the controls are part of the clothing.

The pocket is equipped with textile-integrated sensors that capture information 202 resulting from a manual interaction of the wearer's hand in the pocket, and/or a detected posture of the wearer's hand in the pocket. For example, the inside fabric 830 of the pocket includes pressure sensors 810 that detect manual interaction such as pressure applied with the finger and/or hand against the body. The inside fabric 830 also includes directional force sensors 820 that detect manual interaction such as slide, roll, or shear applied with the finger and/or hand against the body. A posture sensor can include shape-sensitive material such as stretch-sensitive fabric 840 integrated into the inside of the pocket to detect a posture of a finger and/or hand by sensing the insertion or extension of a finger/hand into a portion of the pocket.

For certain devices and for certain actions, the information generated from the sensor 810, 820, 830, 840 can be directly used to operate the device. For others, a processor in communication with the sensors generates control information 204 based on the sensor information. The sensor or control information signal is then relayed to the device via textile conductors that form the communication link 206. The device interprets 208 the received signals and responds accordingly (e.g., cell phones may switch to vibrate mode, a radio may turn off, a jacket sleeve may display a visual message, etc).

In some implementations a function of an action sensor 106 can be dependent on a state of a posture sensor 108. For example, the wearable interface 102 can include a shirt with sleeves. The action sensor 106 is a capacitive touch sensor on the chest portion of the shirt, and the posture sensor 108 is a bend sensor arranged to determine whether an arm is bent beyond a predetermined amount. If the arm is bent to beyond a predetermined threshold, then the touch sensor is active and able to generate a signal in response to sensing a force. If the arm is straight within a predetermined threshold, then the touch sensor is inactive and does not respond to any sensed capacitance change (e.g., to prevent activation when the person's arm is straight and not likely to have been used to touch the chest touch sensor).

In some implementations, a wearable interface can include a first article of clothing that includes an action sensor 106 and a second article of clothing that includes a posture sensor 108. For example, an input sensing system 100 can include an action sensor 106 in a left glove and a posture sensor 108 in a right glove.

3.5 Cursor Control Glove

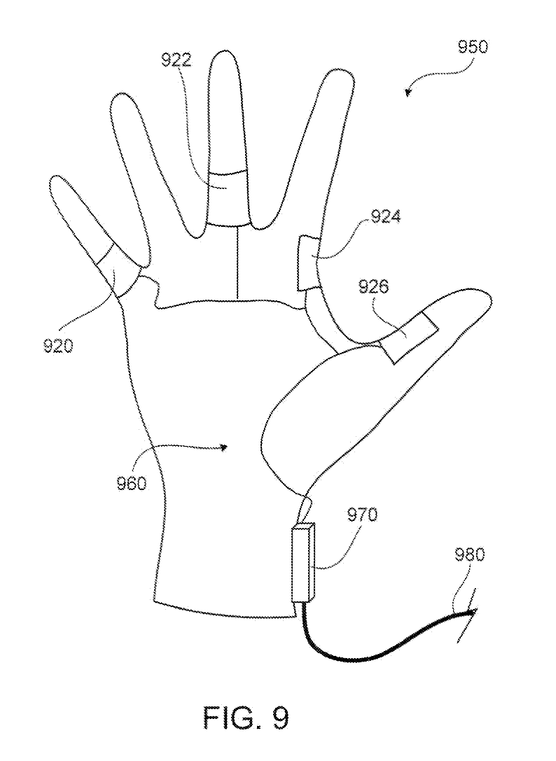

Referring to FIG. 9, a user 230 wearing a glove 950 can control the movement of a cursor or on-screen pointer. The glove 950 has four pressure sensors 920, 922, 924, 926, conduction paths 960, a processing unit 970, and a communication cable 980. These components can be implemented, for example, by quantum tunneling composites (available from Peratech, Ltd.) used as pressure sensors, insulated Aracon wires (available from Minnesota Wire Cable Company) used for conduction paths 960, an AVR AT43USB325 microprocessor used as the processing unit 970, and a USB cable used as the communication cable 980. Other component arrangements and implementations are also possible.

The user 230 can indicate ‘up’ or ‘left’ by applying a torque in a certain direction. The resulting isometric pressure distribution of the hand is sampled and captured 202 by the processing unit 970 via a conduction pathway 960 to each sensor. The processing unit 970 is pre-programmed (and/or calibrated) with the mapping of isometric torque/pressure patterns to desired cursor directions so that the corresponding control information can be generated 204 by the processing unit 970 and transmitted over the communication cable 980.

Exemplary code for generating control information 204 based on sensor readings is shown below.

```
void generateControlInformation(int readings[ ]) {
    // readings from the individual sensors
    int code = processInputs(readings);
    switch (code) {
    case 1:  transmit(270); break;
    case 2:  transmit(90); break;
    case 4:  transmit(0); break;
    case 8:  transmit(180); break;
    case 6:  transmit(45); break;
    case 5:  transmit(315); break;
    case 9:  transmit(225); break;
    case 10: transmit(135); break;
    default:  transmit(unknown); break;
    } // switch
}
int processInputs(int readings[ ]) {
  // look at sensor readings, treat as either ‘pressed’ or ‘unpressed’
  // and translate into a code depending on which are pressed
  int result = 0;
  int mask = 1;
  if (isPushed(readings[3],3)) result += mask;
  mask = mask*2;
  if (isPushed(readings[2],2)) result += mask;
  mask = mask*2;
  if (isPushed(readings[1],1)) result += mask;
  mask = mask*2;
  if (isPushed(readings[0],0)) result += mask;
  return result;
}
```

There are four pressure-sensitive regions on the glove. The reading generated in response to applied pressure on each pressure-sensitive sensor region is an analog value whose magnitude varies with the degree of pressure applied onto the region. Whether or not a region is “pressed” or “unpressed” is determined by comparing the pressure reading to a threshold value.

Sensor readings are passed over the conduction pathway 960 into the processing unit 970. A function generatecontrolInformation( ) takes the sensor readings as input and outputs control information as one of 8 discrete directions, represented as an angle, where 0 represents up, 90 represents right, etc.

A function processInputs( ) represents the state of the four sensor regions as a 4-bit number. Each sensor region is represented by a single bit, and whether the region is “unpressed” or “pressed” determines whether the value of this bit is “0” or “1” respectively. This representation allows for rapid testing of multiple sensor states.

Control information is then communicated by the microprocessor 970 to a receiver 240 via the communication cable 980. This information can then be used to move a cursor, or a virtual tank avatar, a robot, etc. In the case of a cursor, the angle is interpreted 208 to mean which direction to move from the current location. The cursor image can then be moved in the appropriate direction by a predetermined short pixel distance.

This example using the glove 950 allows for 8 discrete directions, but more directions or continuous 360 degree movement is possible by arranging the four pressure-sensitive regions so that they are in close proximity to each other (e.g., the pressure sensitive areas 610, 620, 630 and 640 of the roll sensor 600 in FIG. 6A or the pressure-sensitive components 720, 730, 740, 750 of the shear sensor 700 in FIG. 7B). The four regions represent the four quadrants of the Cartesian axes. This compact arrangement allows all four sensors to be isometrically activated by a single finger (e.g., by a pad on the thumb).

One approach for generating control information 204 accounts for the pressure distribution of all four sensors. The difference in pressure between the regions located on the left half (quadrants corresponding to areas 610 and 640) and the regions located on the right half (quadrants corresponding to areas 620 and 630) corresponds to control in the x direction. The difference in pressure between the regions located on the top half (quadrants corresponding to areas 610 and 620) and the regions located on the bottom half (quadrants corresponding to areas 630 and 640) corresponds to control in the y direction. These pressure differential values can be used directly as the control information; alternatively, an angle from 0 to 360 can be computed using the arc tangent function.

3.6 Soldier Glove

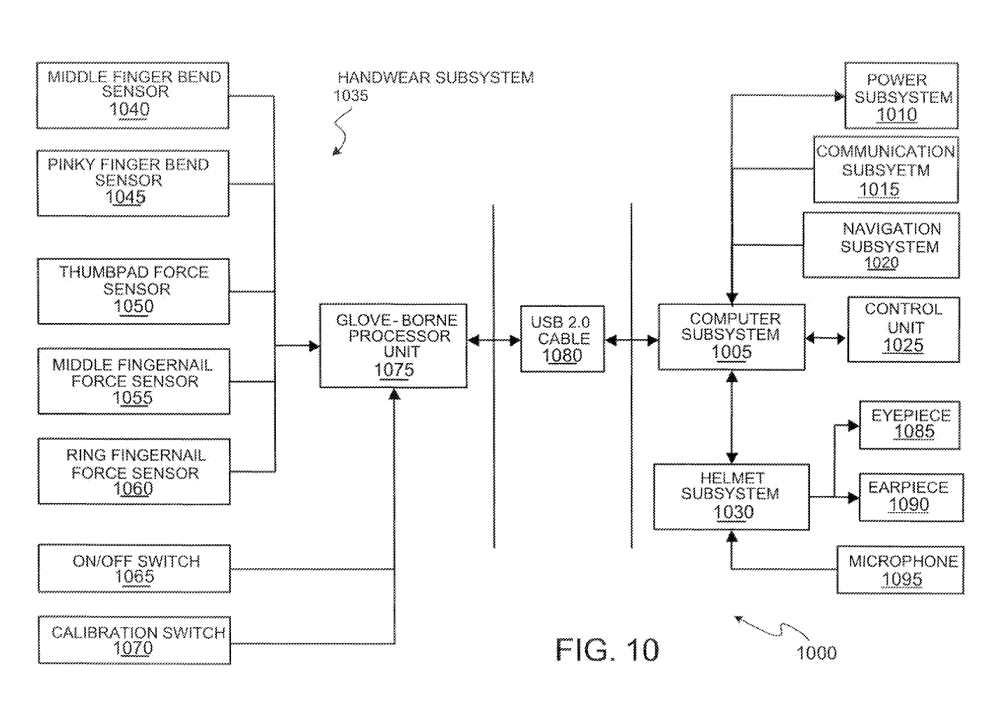

Referring to FIG. 10, a personal system 1000 includes a computer subsystem 1005 connected to power subsystem 1010, communication subsystem 1015, navigation subsystem 1020, control unit 1025, helmet subsystem 1030, and handwear subsystem 1035. A middlefinger bend sensor 1040, pinkyfinger bend sensor 1045, thumbpad force sensor 1050, middlefingemail force sensor 1055, ringfingernail force sensor 1060, on/off switch 1065, and calibration switch 1070 are connected to a glove-borne processor unit 1075 via wires embedded within the glove.

When the handwear subsystem 1035 is turned on via on/off switch 1065, six system modes are activated based on the hand states detected by the sensors (MF=middlefinger, PF=pinkyfinger, MFN=middlefingernail, RFN=ringfingernail, TP=thumbpad):

| | Stand- | | Navi- | | | |
|---|---|---|---|---|---|---|
| | by | Tactical | gation | Com1 | Com2 | Com3 |
| MF Bend | Bent | Ex- | Extended | Bent | Bent | Bent |
| | | tended | | | | |
| PF Bend | Bent | Bent | Extended | Bent | Bent | Extended |
| MFN | Off | Off | Off | On | Off | On |
| Force | | | | | | |
| RFN | Off | Off | Off | Off | On | Off |
| Force | | | | | | |
| TP Force | On/ | On | On | On | On | On |
| | off | | | | | |

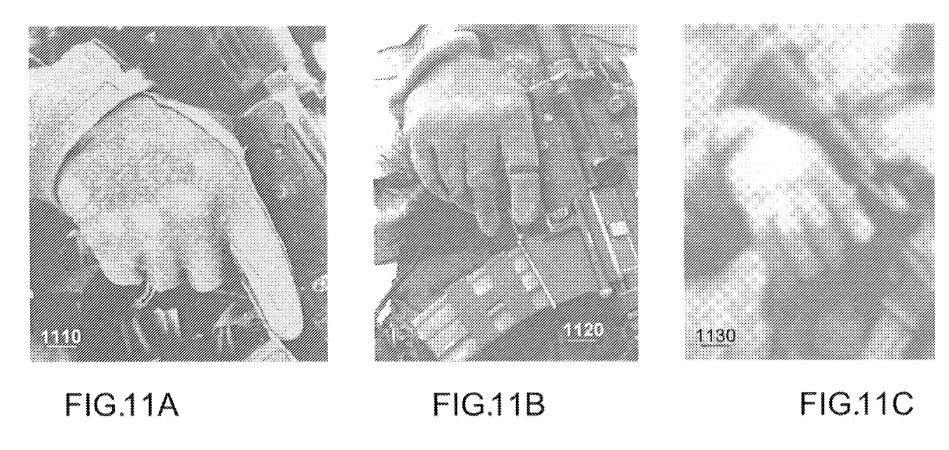

FIGS. 11A-C show a hand of a person wearing the glove and holding a weapon hand grip in standby mode posture 1110 (FIG. 11A), tactical mode posture 1120 (FIG. 11B), and navigation mode posture 1130 (FIG. 11C). The threshold bent/extended or off/on states of the sensors are determined during a calibration process, during which the user presses the calibration switch 1070 and performs a set of free-hand and hand-on-weapon postures. Multiple threshold values for each sensor may be stored in the processor unit 1075, and the threshold value used to determine the state of one sensor may be dependent on the states of the other sensors. Once a mode is recognized, a control input signal is sent from the processor unit 1075 via a cable 1080 (e.g., a USB 2.0 cable) to the computer subsystem 1005, which outputs the appropriate signals to the helmet subsystem 1030 to display navigation information on eyepiece 1085, output audio information via earpiece 1090, activate microphone 1095, etc. Force sensors are available from Peratech Ltd., bend sensors are available from Flexpoint Sensor Systems, Inc., insulated wires and USB 2.0 cable are available from Minnesota Wire & Cable Co., processor unit is available from Microchip Corp., and the glove is available from Hatch (Armor Holdings, Inc.).
3.7 Commander Glove

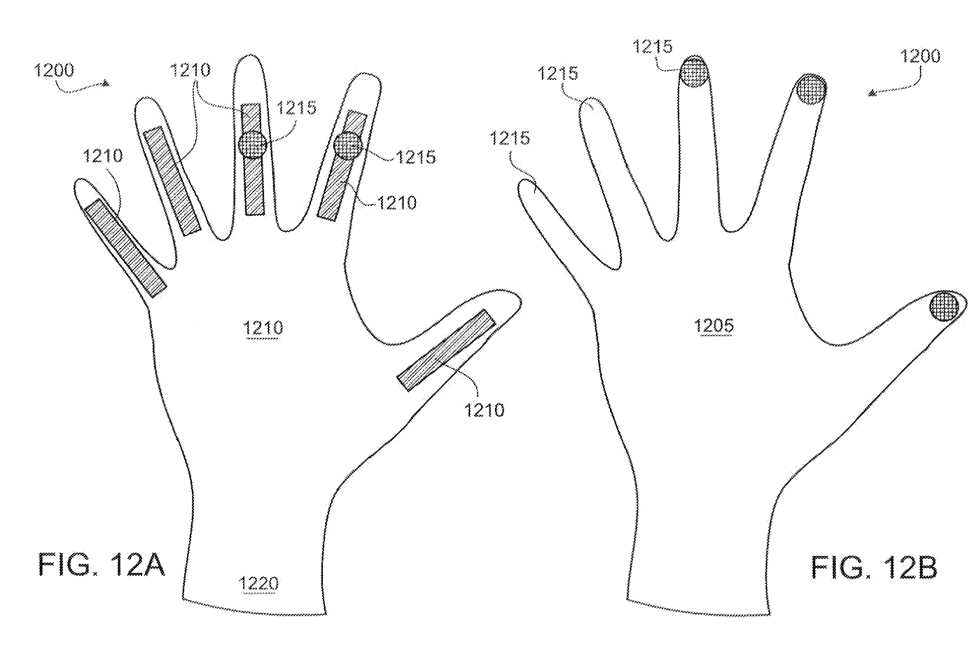

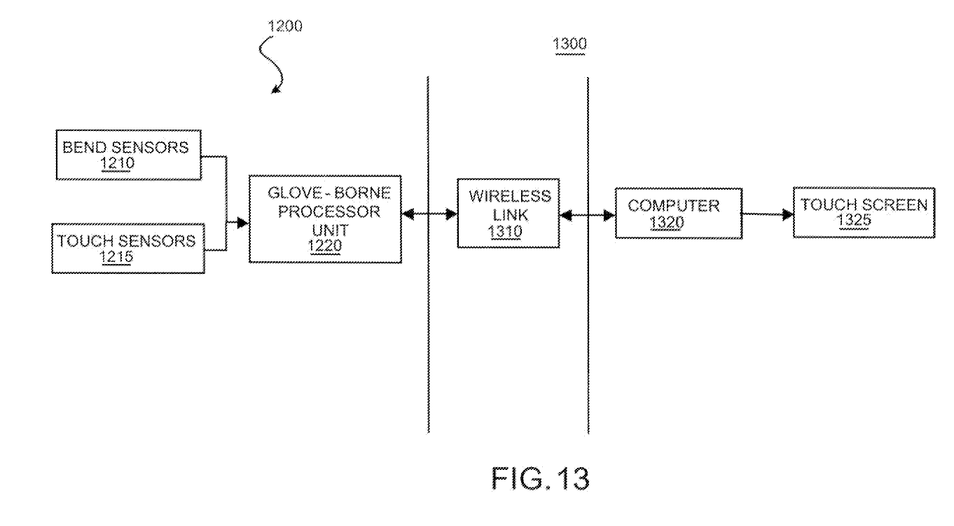

Referring to FIGS. 12A and 12B and FIG. 13, a system 1300 includes a left-handed glove 1200 including bend sensors 1210 and touch sensors 1215. A glove-borne processor unit 1220 outputs information about the states of the bend sensors 1210 and touch 1215 over a wireless link 1310 to a computer 1320 that is linked to a touch screen 1325. The touch sensors 1215 are on both the frontside 1205 and backside 1210 of the glove 1200, and the bend sensors 1210 are on the backside 1210. When glove 1200 is not in communication with the computer 1320, the touch screen 1325 is used in a first “touch screen mode.” For example, when a commander wants to designate a rallying point on the displayed map, he touches the “Rally Point” tab on the displayed menu and proceeds to touch locations on the map that correspond to locations where he would like friendly units to rally. Likewise, to designate an air strike route on the displayed map, the commander navigates a set of menus to reach the “Air Strike Route” tab, touches the tab, and proceeds to draw his intended air strike routes on the map. A variety of other designations can be made in this fashion.

However, with glove 1200 in communication with the computer 1320, the touch screen 1325 is used in a second “touch screen/posture mode” enabling the commander to designate different functions on the displayed map by using different hand postures (e.g., any posture distinguishable by the bend states of the bend sensors 1310) while touching the screen, and also by touching the screen using different parts of his hand (e.g., touching using any of the touch sensors 1315). For example, when the commander extends only his pointer finger and touches the touch screen 1325 with the tip of his pointer finger, he designates a rallying point. Likewise, when the commander extends only his pointer and middle fingers and draws on the touch screen 1325 with the tip of his middle finger, he designates an air strike route. A variety of other designation can be made in this fashion without requiring the commander to select the appropriate touch function from a menu, thus saving time and energy in critical situations when decisions and orders need to be made as efficiently as possible.

3.8 Input Arm Band

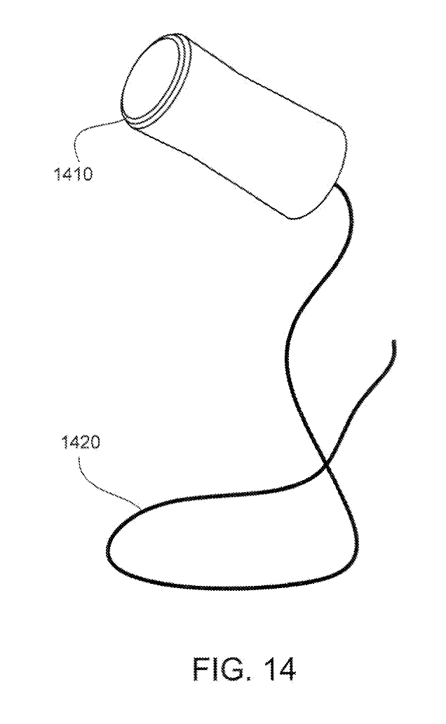

Referring to FIG. 14, isometric hand action from a person is recognized by bioelectric sensors embedded into a forearm band 1310, and the corresponding control signals are transferred to an electronic device via wire(s) 1320. When worn by a person, the forearm band sensors detect muscular activations that can generate signals corresponding to a certain hand posture and interaction. The bioelectric sensors can be electromyogram sensors (available from BioControl Systems, LLC) connected to a processor unit also embedded in the forearm band.

Variations, modifications, and other implementations of what is described herein will occur to those of ordinary skill in the art without departing from the spirit and the scope of the invention as claimed. For example, wearable articles can be worn on other body parts, such as feet or other portions of a leg, and other sensors or algorithms can be used, etc.

Accordingly, the invention is to be defined not by the preceding illustrative description but instead by the spirit and scope of the following claims.

What is claimed is:

1. A method for receiving input from a person, comprising:
sensing a manual interaction performed by the person;
determining a posture of a portion of the person's body; and
generating a signal based on the sensed interaction and the determined posture.

2. The method of claim 1, wherein the manual interaction comprises a force applied by the person against an object.

3. The method of claim 2, wherein the force comprises a force applied in an isometric action.

4. The method of claim 2, wherein the force comprises a force applied in a direction non-orthogonal to a surface of a portion of the object.

5. The method of claim 1, wherein the manual interaction is performed by the portion of the person's body.

6. The method of claim 1, wherein the portion of the person's body comprises a hand.

7. The method of claim 6, wherein the posture comprises a shape state of at least one portion of the hand.

8. The method of claim 6, wherein the manual interaction comprises a force applied by at least one finger of the hand.

9. The method of claim 1, wherein the posture comprises a state of the portion of the person's body with respect to an object.

10. The method of claim 9, wherein the posture comprises a position of the person's hand within a pocket.

11. An article of manufacture, comprising:
a wearable interface; and
one or more sensors arranged in the wearable interface to
sense a manual interaction performed by a person wearing the wearable interface, and
determine a posture of a portion of the body of the person wearing the wearable interface.

12. The article of claim 11, wherein the manual interaction comprises a force applied by the person against an object.

13. The article of claim 12, wherein the force comprises a force applied in an isometric action.

14. The article of claim 12, wherein the force comprises a force applied in a direction non-orthogonal to a surface of a portion of the object.

15. The article of claim 11, wherein the portion of the person's body comprises a hand.

16. The article of claim 11, wherein the wearable interface comprises handwear.

17. The article of claim 16, wherein the handwear comprises a glove.

18. The article of claim 16, wherein at least one of the sensors comprises a bend sensor.

19. The article of claim 11, wherein the wearable interface comprises a pocket.

20. The article of claim 11, wherein at least one of the sensors comprises shape-sensitive material.

21. The article of claim 11, wherein the wearable interface comprises
a first wearable article including a sensor arranged in the first wearable article to sense a manual interaction performed by the person, and
a second wearable article including a sensor arranged in the second wearable article to determine a posture of the portion of the body.

22. The article of claim 11, wherein the sensors are arranged in the wearable article to sense the posture of the portion of the body performing the manual interaction.

23. A method for receiving input from a person, comprising:
sensing a manual interaction with a wearable interface located between a portion of a person's body and an object while the portion of the body is in a posture associated with the object; and
generating a signal based on the sensed interaction.

24. The method of claim 23, wherein the portion of the body being in a posture associated with the object comprises the portion of the body in contact with the object.

25. The method of claim 23, wherein sensing the manual interaction with the wearable interface comprises sensing a force applied by the person on the wearable interface against the object.

26. The method of claim 25, wherein the force comprises a force applied in an isometric action.

27. The method of claim 25, wherein the force comprises a force applied in a direction non-orthogonal to a surface of a portion of the object.

28. The method of claim 23, wherein sensing the manual interaction with the wearable interface comprises sensing rolling of the portion of the person's body on the wearable interface against the object.

29. The method of claim 23, further comprising determining which of multiple pre-determined postures associated with the object is being assumed by the portion of the body.

30. The method of claim 29, wherein generating the signal based on the sensed interaction comprises generating a signal in response to the sensed interaction based on the determined posture.

31. The method of claim 23, wherein generating the signal based on the sensed interaction comprises generating a signal in response to the sensed interaction based on information indicating a type of the object.

32. A system for receiving input from a person, comprising:
a wearable interface including one or more sensors arranged to sense a manual interaction between a portion of the person's body and an object, and arranged to be compatible with a posture of the portion of the body associated with the object; and
an input module in communication with the wearable interface including circuitry to generate a signal based on the sensed interaction.

33. The system of claim 32, wherein the portion of the body being in a posture associated with the object comprises the portion of the body in contact with the object.

34. The system of claim 32, wherein sensing the manual interaction between the portion of the person's body and the object comprises sensing a force applied by the person against the object.

35. The system of claim 34, wherein the force comprises a force applied in an isometric action.

36. The system of claim 34, wherein the force comprises a force applied in a direction non-orthogonal to a surface of a portion of the object.

37. The system of claim 34, wherein sensing the manual between the portion of the person's body and the object comprises sensing rolling of the portion of the person's body on a surface of a portion of the object.

38. The system of claim 32, wherein the input module is in communication with the wearable interface over at least one of a wired channel, a wireless channel, or an optical channel.

39. A method for receiving input from a person, comprising:
sensing a force applied to a wearable interface located between a portion of a person's body and an object;
determining a direction associated with the sensed force.

40. The method of claim 39, wherein sensing the force applied to the wearable interface comprises sensing a force applied to a plurality regions of the interface.

41. The method of claim 40, wherein determining a direction associated with the sensed force comprises determining a difference in force applied to the plurality of regions of the interface.

42. A system for receiving input from a person, comprising:
a wearable interface including one or more sensors arranged to sense a force applied to the interface located between a portion of a person's body and an object; and
an input module in communication with the interface including circuitry to determine a direction associated with the sensed force.

43. The system of claim 42, wherein the wearable interface is configured to determine a difference in force applied to regions of the interface, and transmit a signal indicative of the difference to the input module.

44. The system of claim 43, wherein the circuitry is configured to determine the direction associated with the sensed force based on the signal.

45. The system of claim 42, wherein the wearable interface is configured to transmit a plurality of signals indicative of force applied to a plurality regions of the interface.

46. The system of claim 45, wherein the circuitry is configured to determine a difference in force applied to regions of the interface based on the plurality of signals.
